(19) United States
(12) Patent Application Publication
(10) Pub. No.: US 2011/0011671 A1
(43) Pub. Date: Jan. 20, 2011

(54) Belaying apparatus with friction claw for climbing

(76) Inventor: Young Chu, (US)

Correspondence Address: Young Chu, Suite 1722, 3600 Wilshire Blvd., Los Angeles, CA, 90010, US

(21) Appl. No.: 12/460,339

(22) Filed: Jul. 16, 2009

(51) Int. Cl. A62B 35/00

(52) U.S. Cl. 182/5

(57) ABSTRACT

A manual belaying descending device for belaying a climber and for controlled descending, on a single or double rope, comprised of an aluminum body having two slots. Each slot is for a rope to pass through and adjacent to the slots is the main opening of the device for receiving one or multiple carabiners, in a manner that at least one loop of the rope may pass through at least one carabiner and a friction claw coupled with fixed stop means transversely offset to said openings for limiting the movement of the rope by providing paths of resistance.

### FIELD OF THE INVENTION

This invention relates to belaying descending devices, more specifically to manual belaying descending devices.

### BACKGROUND OF THE INVENTION

This invention pertains to a device used, in conjunction with 1 rope or 2, to stop a falling object and/or to lower an object in a controlled manner. In particular it pertains to a belay device used in the sports of rock climbing, mountaineering and trekking and, more specifically, to a manual belay device.

When rock climbing, a belay device is used to protect a climber from injury and/or death in the case of a fall. The climber wears a harness to which one end of a given rope is attached. The rope passes through a belay device that is often attached to the harness of another person, referred to as the “belayer”. The belayer operates the belay device and typically remains at a stable point while the climber ascends. When the climber is “lead” climbing, the climber drags the rope up the rock as he ascends. At various points during the ascent, the climber clips the rope into metal loops (“carabiners”) that are attached to the surface of the rock formation. When the climber is “top-rope” climbing, the rope extends down toward the climber from above. In the case of lead climbing, the belayer feeds out rope as the climber ascends. In the case of top-rope climbing, the belayer takes in rope as the climber ascends. In either case, if the climber falls, the belayer must grasp the rope securely by means of the belay device. The fall is therefore stopped by means of the belay device and the climber comes to rest suspended from above by the rope. Then, the belayer may gently lower the climber to the ground by operating the belay device so as to gradually release tension on the rope.

Manual belay devices, consists of relatively simple devices that contain no moving parts. These devices rely entirely upon frictional forces developed within a torturous path through which the rope runs. These devices are inexpensive since they are based on simple designs and contain no moving parts. Furthermore, these devices require action on the part of the belayer in order to stop a fall and necessitate significant levels of strength to control the rope. If the belayer looses his grip after the initial stop from the impact, the result can lead to death of the climber. Moreover, it is difficult to hold on to the rope if the climber is significantly heavy, endangering the climber being supported. Additional negatives include flimsy construction as in U.S. Pat. No. D466,794 to Malkiel, only one friction point per rope as in U.S. Pat. No. 6,681,891 to Richard et al. and inefficient design dimensions as in U.S. Pat. No. 413,786 to Graham.

The devices described in the above mentioned patents, do not disclose, teach or illustrate the unique structure, function and advantage of the subject belay device.

The ideal characteristics of a manual belaying apparatus are:

A. The manual belay device should grip the rope very tightly when the climber falls and continue to grip the rope for long period without causing fatigue on belayer's hand. Sometimes climbers fall from a very steep wall. The device must be able to stop a heavy climber who has been in a free fall and continue to hold the climber for long period without causing fatigue on the belayer's hand. While conventional manual belay devices typically have one friction point, an ideal device should contain additional friction points to prevent rope slippage caused by fatigue hand.

B. The manual belay device should render the climber in a safe position should the belayer eventually loose his grip on the rope from fatigue.

C. The manual belay device should allow for the belayer to easily lower the climber in a controlled fashion, while minimizing strain on the belayer's hands and arms.

### SUMMARY OF INVENTION

The present invention addresses the problems of the prior art and provides additional security and safety features to prevent injury/death to a climber or belayer.

The device according to the invention is characterized in that it includes an aluminum body having:
two slots for one or two ropes to pass,
a main opening for attaching one or multiple carabiners designed to pass through at least one loop of the rope or ropes,
a friction claw to provide additional friction for the rope or ropes,
and stop means transversely offset with respect to said openings for blocking the rope.

According to a preferred embodiment of the invention, the aluminum body is composed of a central plate whereon a U-shaped bracket is fitted bounding two symmetrical slots on each side of the central plate. The large opening is arranged in the central plate extending in the vertical mid-plane. The body of the bracket is provided in the middle zone with two centering grooves designed to engage in the central plate.

According to one feature of the invention, the assembly means pass through the ends of the bracket and of the central plate forming said stop means for blocking the rope, within both slots.

According to another feature of the invention, a friction claw is arranged on central plate, in a circular fashion, to improve blocking of the rope and to create an alternate path of resistance.

According to another feature, two pins designed to enter two holes on the central plate transversely will also block the rope.

The holes present a circular shape with a circular central part for the assembly means to pass.

### BRIEF DESCRIPTION OF THE DRAWINGS

The present invention is illustrated by way of example and not by way of limitation, in the figures of the accompanying drawings and in which like reference numerals refer to similar elements and in which:

FIG. 1 is a perspective view of the manual belaying descending device according to the invention;

FIG. 2 illustrates a bottom perspective view of the manual belaying descending device;

FIG. 3 represents a side perspective view of the manual belaying descending device;

FIG. 4 illustrates the mode of use of the device for belaying a climber in a conventional way;

FIG. 5 illustrates the mode of use of the device for belaying a climber with an additional friction point;

### DETAILED DESCRIPTION OF EMBODIMENTS

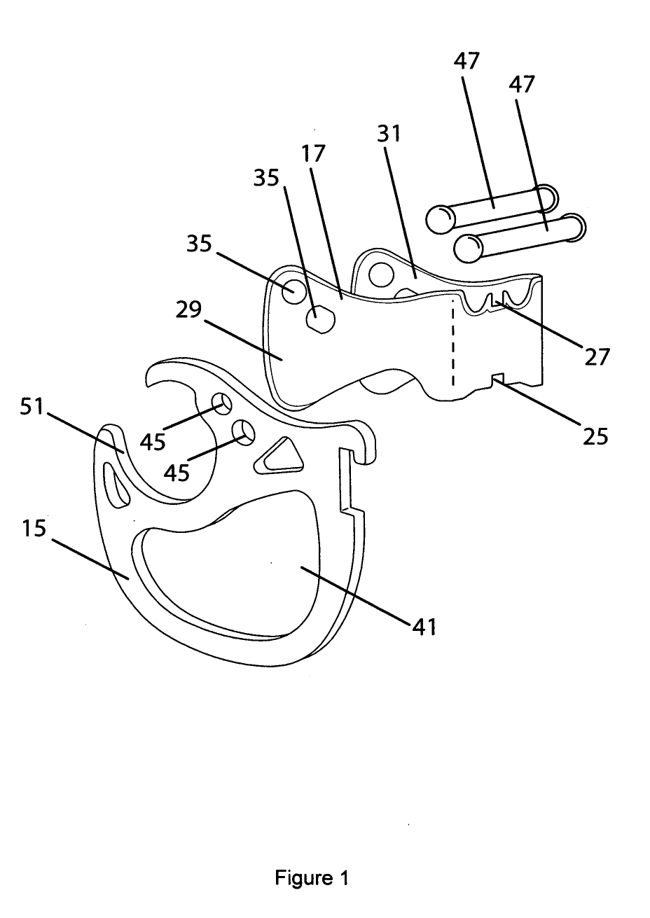

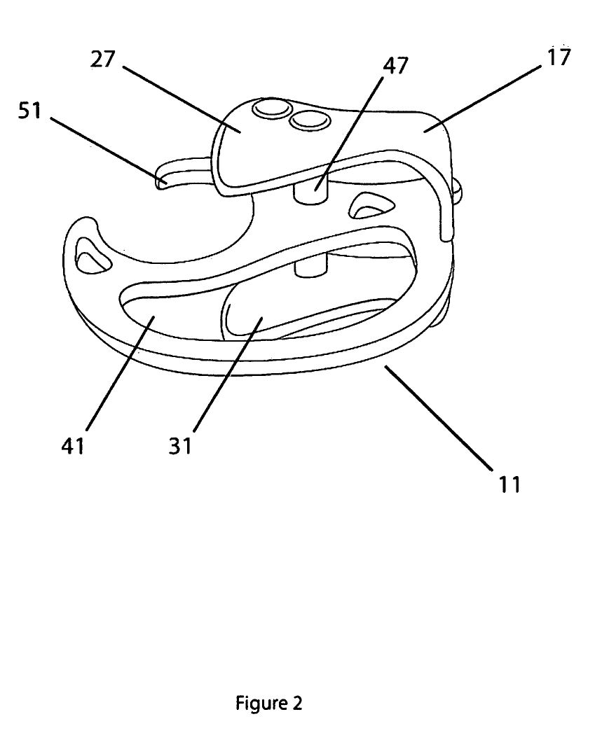

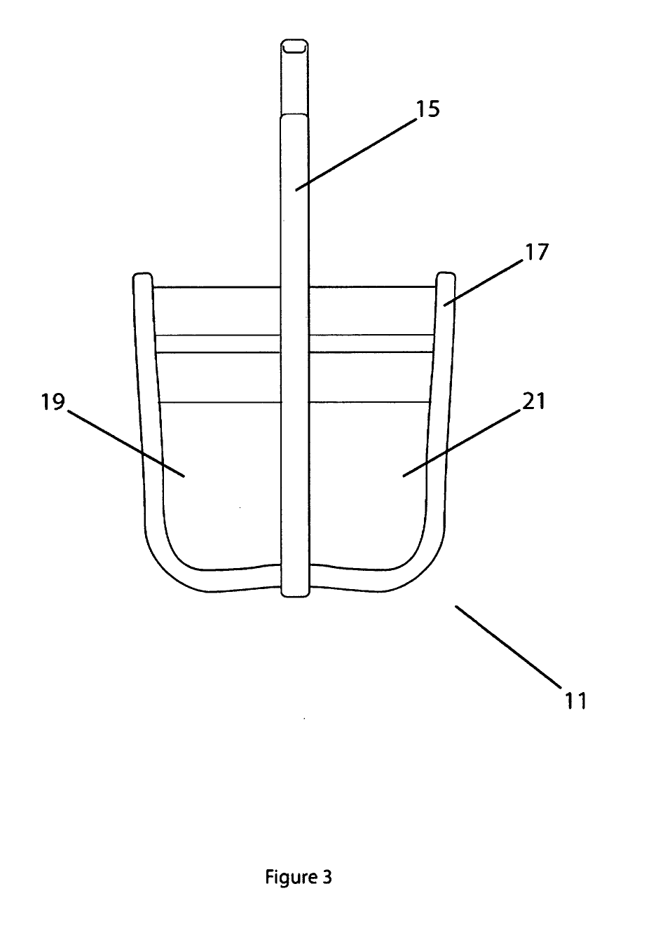

With reference to FIGS. 1 to 3, a belaying descending device 11 for climbing includes an aluminum central plate 15 whereon a U-shaped aluminum bracket 17 is fitted so as to define two adjacent slots 19, 21 for the rope or ropes to pass through.

The center of the bracket 17 is provided with two centering grooves 25, 27 aligned in the plane of the central plate 15. The ends of the U-shaped bracket 17 are two symmetrical wings 29, 31 fitted with circular holes 35, designed to receive an assembly means 47, i.e. a rivet/pin, passing coaxially through the holes 35 and the central plate 15 in the transverse direction. The assembly means forms a fixed stop means that closes the corresponding slot 19, 21 to improve blocking and friction of the rope in the event of a fall or slip.

The central plate 15 extends in the vertical mid-plane and is composed of a main opening 41, for attaching one or more carabiners for belaying the second climber. Two additional holes 45, are also provided in the central plate 15, to enable the passage of the assembly means 47. The central plate 15 also contains a friction claw 51, which provides further friction points to restrain and control the rope or ropes for belaying a climber or descending a climber.

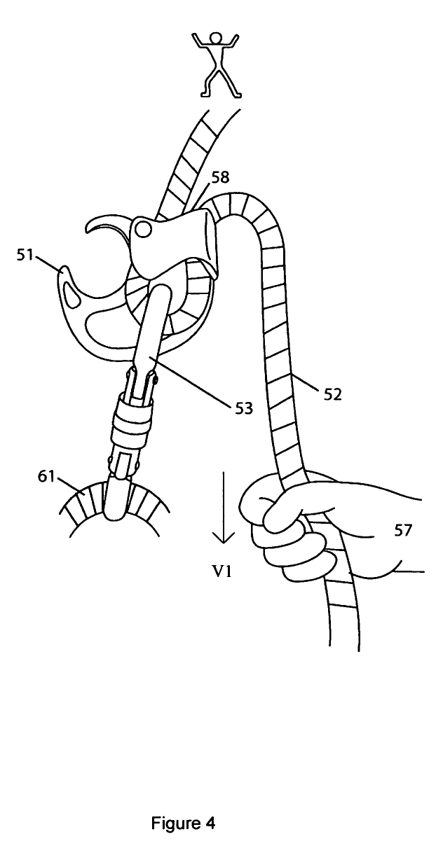

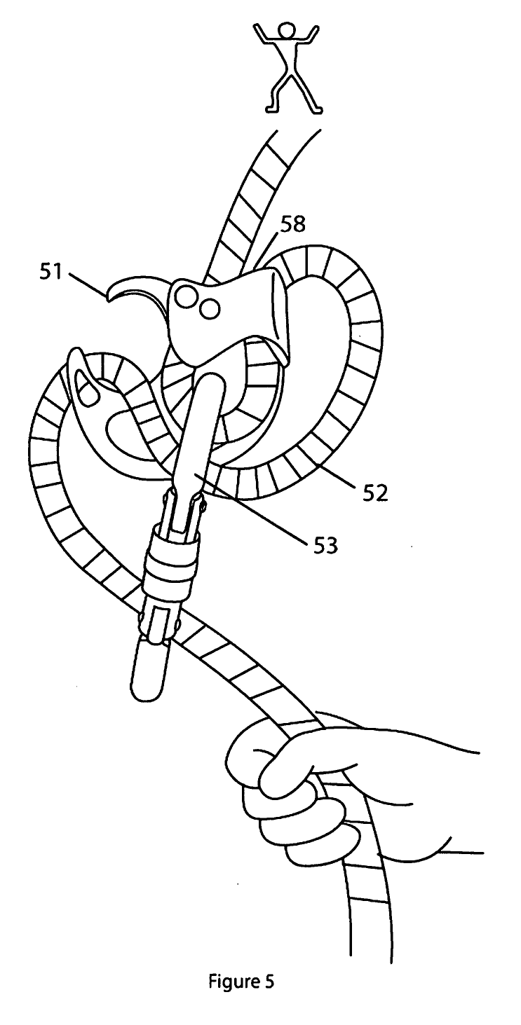

The present device can be used with a single rope or a double rope. When using a single rope as in FIGS. 4 and 5, a loop of the rope passes longitudinally through a single slot 19 or 21 in an offset plane parallel to the central plate 15. In the case of a double rope (not represented), the two slots 19, 21 are used with two loops of rope that extend in parallel fashion on each side of the central plate 15.

As the climber is climbing, the belayer is the second climber that is underneath the first (FIG. 5). One loop of the single rope is housed in slot 19 or slot 21 of the belaying descending device 11 and a first carabiner passes through the rope loop main opening of the device 41 and the belayer's safety harness. One of the belayer's hands 57 is holding the lower strand of the extending rope 52.

During normal progression of the first climber, one of the belayer's hands 57 must give slack or tighten the rope. The friction claw 51 of the device 11 allows the belayer to add extra friction instantly to support the first climber by coiling the rope around the friction claw 51 (FIG. 5). Conventional manual belay devices lack this friction claw, which is hazardous for climbing because less friction is available to support the first climber for a long period. To block the first climber from falling the belayer must clasp his hand 57 pulling the rope 52 in the direction of V1 (FIG. 4). However, if the first climber falls from a significantly steep face, an overwhelming amount of pressure is placed on only one hand of the belayer 57. The friction claw 51 provides more surface area to coil the rope 52. The friction claw 51 affords another path of resistance, alleviating the amount of pressure and force on the belayer's hands.

The present invention directly addresses three main shortcomings of previous manual belay devices. When a climber is suspended in the air and being supported by a belayer the amount of stress on the belayer's arms and hands are greatly reduced; the belayer can support the climber for longer and in a stable fashion by coiling extra rope around the friction claw. Additionally, when the climber is being lowered by the belayer, the added friction provided by coiling the rope around the friction claw, considerably reduces fatigue on the belayer's hands and arms allowing the belayer to lower the climber in a safe, balanced and controlled fashion. Lastly, a climber using the present invention can rappel themselves with greater ease and stability with the friction claw. With conventional rappel devices the one who is rappelling must support their own body weight using their hands, arms and the friction of the rope. The friction claw in the present invention relieves the stress of the hands, arms, harness and belay device by redirecting extra pressure on the friction claw. By eradicating the weaknesses prevalent in conventional manual belay devices, the present invention provides added safety features and functionality necessary to ensure the continued safety of climbing enthusiasts.

What is claimed is:

1. A belaying descending device for belaying and lowering a leading climber and for controlled descending along a single or double rope, comprising an aluminum body having: a pair of slots for one or two ropes to pass through, a main opening for receiving one or multiple carabiners in a manner that at least one loop of the rope may pass through the first carabiner, fixed stop means transversely offset with respect to said openings for limiting the movement of the rope through the slots and a friction claw positioned near said slots to provide additional friction for the rope and to maximize pressure on the present invention and away from the belayer's hands.

2. The belaying descending device according to claim 1, wherein the aluminum body is composed of a central plate whereon a U-shaped bracket is fitted bounding the pair of slots on each side of the central plate.

3. The belaying descending device according to claim 2, wherein the two openings are arranged in the central plate extending in the vertical mid-plane.

4. The belaying descending device according to claim 3, wherein the main opening, for attaching said carabiners, of the device is adjacent to said slots.

5. The belaying descending device according to claim 2, wherein said bracket has a middle zone provided with two centering grooves designed to engage in the central plate.

6. The belaying descending device according to claim 2, wherein assembly means (i.e. rivets) pass through the bracket and the flange-plate forming said stop means for blocking the rope.
